(19) United States
(12) Patent Application Publication
(10) Pub. No.: US 2020/0359399 A1
(43) Pub. Date: Nov. 12, 2020

(54) Method and Apparatus for Identifying Interference in a Wireless Communication System

(71) Applicant: GUANGDONG OPPO MOBILE TELECOMMUNICATIONS CORP., LTD., Dongguan, Guangdong (CN)

(72) Inventor: Zhi Zhang, Dongguan, Guangdong (CN)

(21) Appl. No.: 16/765,319

(22) PCT Filed: Nov. 29, 2018
(86) PCT No.: PCT/CN2018/118272

§ 371 Date: May 19, 2020

Related U.S. Application Data
(60) Provisional application No. 62/592,124, filed on Nov. 29, 2017.

(51) Int. Cl. H04W 72/12; H04B 1/525; H04W 72/08; H04W 76/27

(52) U.S. Cl. CPC H04W 72/1268; H04B 1/525; H04W 72/1226; H04W 76/27; H04W 72/082

(57) ABSTRACT

A method and an apparatus for identifying interference in a wireless communication system are provided. The method for identifying interference in a wireless communication system of a user equipment includes receiving scheduling information from a network node and detecting whether an intermodulation (IM) interference is going to occur according to the scheduling information.

### CROSS-REFERENCE TO RELATED APPLICATION(S)

This application is a 371 application of International Application No. PCT/CN2018/118272, filed on Nov. 29, 2018, which claims priority to U.S. provisional application No. 62/592,124, filed on Nov. 29, 2017, the entire disclosure of both of which are hereby incorporated by reference in their entireties.

### TECHNICAL FIELD

The present disclosure relates to the field of communication systems, and more particularly, to a method and an apparatus for identifying interference in a wireless communication system.

### BACKGROUND

In new radio (NR) systems, a user equipment may transmit signals on many carriers and receive signals on many carriers simultaneously. These carriers may use NR and/or long term evolution (LTE) on different frequencies. When different frequencies of these carriers satisfy specific conditions, for example, when combinations of multiple of different transmit carrier frequencies overlap or partially overlap receiving carrier frequencies, transmitted signals or a combination of transmitted signals will generate interference to the receiving carriers. If multiple transmitted signals generate interference to a receiver, this is called intermodulation (IM) interference. If one transmitted signal generates interference to the receiver, this is called harmonic interference.

There is a need to provide a new technical solution for identifying interference in a wireless communication system.

### SUMMARY

An object of the present disclosure is to propose a method and an apparatus for identifying interference in a wireless communication system.

In a first aspect of the present disclosure, a user equipment for identifying interference in a wireless communication system includes a memory, a transceiver, and a processor coupled to the memory and the transceiver. The processor is configured to control the transceiver to receive scheduling information from a network node and detect whether an intermodulation (IM) interference is going to occur according to the scheduling information.

In a second aspect of the present disclosure, a method for identifying interference of a user equipment in a wireless communication system includes receiving scheduling information from a network node and detecting whether an intermodulation (IM) interference is going to occur according to the scheduling information.

In a third aspect of the present disclosure, a network node for identifying interference in a wireless communication system includes a memory, a transceiver, and a processor coupled to the memory and the transceiver. The processor is configured to control the transceiver to transmit, to a user equipment, scheduling information and detect whether an intermodulation (IM) interference is going to occur according to the scheduling information.

In a fourth aspect of the present disclosure, a method for identifying interference of a network node in a wireless communication system includes transmitting, to a user equipment, scheduling information and detecting whether an intermodulation (IM) interference is going to occur according to the scheduling information.

In a fifth aspect of the present disclosure, a non-transitory machine-readable storage medium has stored thereon instructions that, when executed by a computer, cause the computer to perform the above method.

In a sixth aspect of the present disclosure, a terminal device includes a processor and a memory configured to store a computer program. The processor is configured to execute the computer program stored in the memory to perform the above method.

In a seventh aspect of the present disclosure, a network node includes a processor and a memory configured to store a computer program. The processor is configured to execute the computer program stored in the memory to perform the above method.

### BRIEF DESCRIPTION OF DRAWINGS

In order to more clearly illustrate the implementations of the present disclosure or related art, the following figures which will be described in the implementations are briefly introduced. It is obvious that the drawings are merely some implementations of the present disclosure, a person having ordinary skill in this field can obtain other figures according to these figures without paying the premise.

FIG. 1 is a block diagram of a user equipment and a network node for identifying interference in a wireless communication system according to an implementation of the present disclosure.

FIG. 2 is a flowchart illustrating a method for identifying interference of a user equipment according to an implementation of the present disclosure.

FIG. 3 is a flowchart illustrating a method for identifying interference of a network node according to an implementation of the present disclosure.

FIG. 4 is a block diagram of a system for wireless communication according to an implementation of the present disclosure.

### DETAILED DESCRIPTION

Implementations of the present disclosure are described in detail with the technical matters, structural features, achieved objects, and effects with reference to the accompanying drawings as follows. Specifically, the terminologies in the implementations of the present disclosure are merely for describing the purpose of the certain implementation, but not to limit the disclosure.

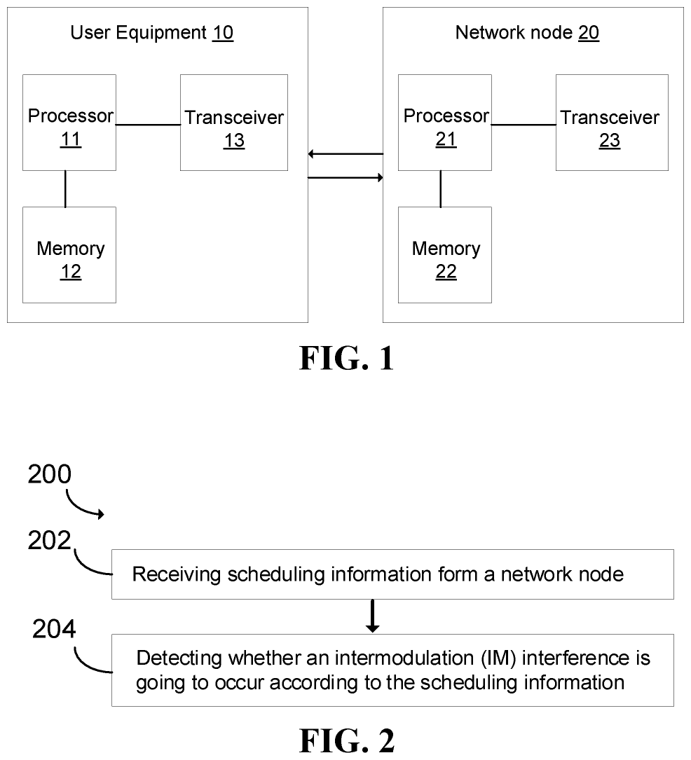

FIG. 1 illustrates that, in some implementations, a user equipment (UE) 10 and a network node 20 are configured to identify interference in a wireless communication system according to an implementation of the present disclosure. The UE 10 may include a processor 11, a memory 12 and a transceiver 13. The network node 20 may include a processor 21, a memory 22 and a transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the implementations are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) new radio (NR) Release 16 and beyond. UEs are communicated with each other directly via a sidelink interface such as a PC5 interface.

In some implementations, the processor 11 is configured to control the transceiver 13 to receive scheduling information from the network node 20 and detect whether an intermodulation (IM) interference is going to occur according to the scheduling information.

In some implementations, the transceiver 13 is configured to transmit a report, to the network node 20, that if the processor 11 is feasible to detect that the IM interference is going to occur. The report is transmitted via a dedicated signaling. The dedicated signaling is for example, a radio resource control (RRC) signaling. The transceiver 13 is further configured to receive a signal from the network node 20, wherein the signal indicates that the network node 20 is feasible to detect that the IM interference is going to occur. The signal received from the network node 20 is a dedicated signaling or a common signaling.

In some implementations, the processor 11 is configured to control the transceiver 13 to indicate a single uplink (UL) transmission to the network node 20 or the user equipment 10 is in a single UL transmission mode.

In some implementations, if the user equipment 10 and the network node 20 are both feasible of detecting that the IM interference is going to occur, the transceiver 13 is configured to receive a signal for indicating a single uplink transmission to the network node 20, or receive a signal for configuring the user equipment 10 in a single UL transmission mode from the network node 20.

In some implementations, the processor 21 is configured to control the transceiver 23 to transmit, to the user equipment 10, scheduling information and detect whether an intermodulation (IM) interference is going to occur according to the scheduling information.

In some implementations, the transceiver 23 is configured to receive a report that if the user equipment 10 is feasible to detect that the IM interference is going to occur from the user equipment 10. The report is transmitted by the transceiver 23 via a dedicated signaling. The dedicated signaling is for example, a radio resource control (RRC) signaling.

In some implementations, the processor 21 is configured to control the transceiver 23 to transmit a signal to the user equipment 10 to indicate that the network node 20 is feasible to detect that the IM interference is going to occur. The signal received from the network node 20 is a dedicated signaling or a common signaling.

In some implementations, the processor 21 is configured to control the transceiver 23 to transmit a signal to the user equipment 10 to indicate a single uplink transmission from the user equipment 10 to the network node 20, or to configure the user equipment 10 in a single uplink transmission mode.

In some implementations, if the user equipment 10 and the network node 20 are both feasible of detecting that the IM interference is going to occur, the processor 21 is configured to control the transceiver 23 to transmit a signal to the user equipment 10 to indicate a single uplink transmission from the user equipment 10 to the network node 20, or to configure the user equipment 10 in a single uplink transmission mode.

FIG. 2 illustrates a method 200 for identifying interference of the user equipment 10 according to an implementation of the present disclosure. The method 200 includes: at block 202, receiving scheduling information from the network node 20, and at block 204, detecting whether an intermodulation (IM) interference is going to occur according to the scheduling information.

In some implementations, the method 200 further includes transmitting a report, to the network node 20, that if the user equipment 10 is feasible to detect that the IM interference is going to occur. The report is transmitted via a dedicated signaling. The dedicated signaling is for example, a radio resource control (RRC) signaling.

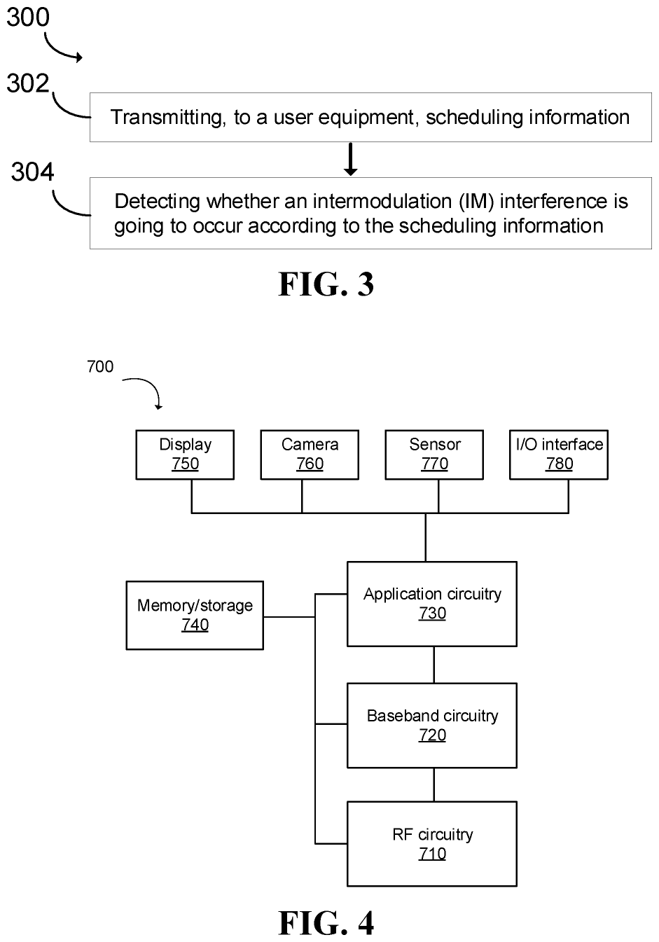

FIG. 3 illustrates a method 300 for identifying interference of the network node 20 according to an implementation of the present disclosure. The method 300 includes: at block 302, transmitting, to the user equipment 10, scheduling information, and at block 304, detecting whether an intermodulation (IM) interference is going to occur according to the scheduling information.

In some implementations, the method 300 further includes receiving a report that if the user equipment 10 is feasible to detect that the IM interference is going to occur from the user equipment 10. The report is transmitted via a dedicated signaling. The dedicated signaling is for example, a radio resource control (RRC) signaling.

In some implementations, the method 300 further includes transmitting a signal to the user equipment 10 for indicating that the network node 20 is feasible to detect that the IM interference is going to occur. The signal a dedicated signaling or a common signaling.

In some implementations, the method 300 further includes transmitting a signal to the user equipment 10 to indicate a single uplink transmission from the user equipment 10 to the network node 20, or to configure the user equipment 10 in a single uplink transmission mode.

In some implementations, if the user equipment 10 and the network node 20 are both feasible of detecting that the IM interference is going to occur, the method 300 further includes transmitting a signal to the user equipment 10 to indicate a single uplink transmission from the user equipment 10 to the network node 20, or to configure the user equipment 10 in a single uplink transmission mode.

In some implementations, one method is provided to solve the IM interference, the user equipment 10 with multiple uplink links can be allowed to switch among different uplink links and as a result, just one uplink link is kept at one time. If the user equipment 10 keeps just one uplink link at one time, the IM interference will not exist. Existence of the IM interference depends on uplink transmission bandwidth and downlink transmission bandwidth, and this requires that network node 20 and the user equipment 10 can both be aware of the existence of the IM interference. The implementation of the present disclosure can solve this issue and provides how the network node 20 and the user equipment 10 can both be aware of the existence of the IM interference.

In some implementations, on the user equipment 10 side, there is a feasibility issue if the user equipment 10 can be aware of the existence of the IM interference. One example is that uplink transmission(s) and downlink transmission(s) belong to different radio access technologies (RATs), such as long term evolution (LTE) and new radio (NR) dual connectivity case. In details, one of the uplink transmission(s) and downlink transmission(s) is on the LTE side and the other of the uplink transmission(s) and downlink transmission(s) is on the NR side. In this example, LTE and NR may be on different modems. The scheduling information is obtained by different modems separately. It is understood that, the user equipment 10 needs to aggregate the scheduling information from both LTE and NR, then the user equipment 10 can decide whether or not the IM interference may happen.

In some implementations, on the network node 20 side, to decide whether or not the IM interference may happen, LTE and NR network nodes, such as base stations, need to exchange the scheduling information. Therefore, on the network node 20 side, there is also similar feasibility issue as on the user equipment 10 side.

To solve the above problems, such as the feasibility issues on the user equipment 10 and the network node 20 side, some implementations are as follows.

1. The user equipment 10 can report to the network node 20 (such as base station) that if it is feasible to detect the IM interference may happen, by means of, for example, the scheduling information from the network node 20.

2. The network node 20 can signal the user equipment 10 that if it is also feasible to detect the IM interference may happen.

3. If the user equipment 10 and the network node are both feasible of detecting the IM interference may happen, the network node 20 can signal the user equipment 10 that the user equipment 10 can indicate a single uplink transmission to the network node 20 when the user equipment 10 detect the IM interference may happen or the network node 20 can configure the user equipment 10 in a single uplink transmission mode.

In details, the above UE report can be dedicated signaling, such as RRC signaling. The network node 20 can use dedicated signaling to inform the user equipment 10 of its feasibility or the network node 20 can use common signaling such as in the system information to inform all UEs in a cell about its feasibility.

FIG. 4 is a block diagram of an example system 700 for wireless communication according to an implementation of the present disclosure. Implementations described herein may be implemented into the system using any suitably configured hardware and/or software. FIG. 4 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some implementations, the baseband circuitry may provide for communication compatible with one or more radio technologies. For example, in some implementations, the baseband circuitry may support communication with an evolved universal terrestrial radio access network (EUTRAN) and/or other wireless metropolitan area networks (WMAN), a wireless local area network (WLAN), a wireless personal area network (WPAN). Implementations in which the baseband circuitry is configured to support radio communications of more than one wireless protocol may be referred to as multi-mode baseband circuitry.

In various implementations, the baseband circuitry 720 may include circuitry to operate with signals that are not strictly considered as being in a baseband frequency. For example, in some implementations, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various implementations, the RF circuitry may include switches, filters, amplifiers, etc. to facilitate the communication with the wireless network.

In various implementations, the RF circuitry 710 may include circuitry to operate with signals that are not strictly considered as being in a radio frequency. For example, in some implementations, RF circuitry may include circuitry to operate with signals having an intermediate frequency, which is between a baseband frequency and a radio frequency.

In various implementations, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some implementations, the electronic device circuitry may be implemented in, or functions associated with the circuitry may be implemented by, one or more software or firmware modules.

In some implementations, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one implementation may include any combination of suitable volatile memory, such as dynamic random access memory (DRAM)), and/or non-volatile memory, such as flash memory.

In various implementations, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various implementations, the sensor 770 may include one or more sensing devices to determine environmental conditions and/or location information related to the system. In some implementations, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various implementations, the display 750 may include a display, such as a liquid crystal display and a touch screen display. In various implementations, the system 700 may be a mobile computing device such as, but not limited to, a laptop computing device, a tablet computing device, a netbook, an ultrabook, a smartphone, etc. In various implementations, system may have more or less components, and/or different architectures. Where appropriate, methods described herein may be implemented as a computer program. The computer program may be stored on a storage medium, such as a non-transitory storage medium.

In the implementation of the present disclosure, a method and an apparatus for identifying interference in a wireless communication system are provided. The implementation of the present disclosure is a combination of techniques/processes that can be adopted in 3GPP specification to create an end product.

A person having ordinary skill in the art understands that each of the units, algorithm, and steps described and disclosed in the implementations of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned implementation since the working processes of the above-mentioned system, device, and unit are basically the same. For easy description and simplicity, these working processes will not be detailed.

It is understood that the disclosed system, device, and method in the implementations of the present disclosure can be realized with other ways. The above-mentioned implementations are examples only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the implementations. Moreover, each of the functional units in each of the implementations can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the implementations of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred implementations, it is understood that the present disclosure is not limited to the disclosed implementations but is intended to cover various arrangements made without departing from the scope of the broadest interpretation of the appended claims.

1. A user equipment for identifying interference in a wireless communication system, comprising:
a memory;
a transceiver; and
a processor coupled to the memory and the transceiver,
wherein the processor is configured to:
control the transceiver to receive scheduling information from a network node; and
detect whether an intermodulation (IM) interference is going to occur according to the scheduling information.

2. The user equipment of claim 1, wherein the transceiver is configured to transmit a report, to the network node, that if the processor is feasible to detect that the IM interference is going to occur.

3. The user equipment of claim 2, wherein the report is transmitted via a dedicated signaling.

4. The user equipment of claim 3, wherein the dedicated signaling is a radio resource control (RRC) signaling.

5. The user equipment of claim 1, wherein the transceiver is further configured to receive a signal from the network node, wherein the signal indicates that the network node is feasible to detect that the IM interference is going to occur.

6. The user equipment of claim 5, wherein the signal received from the network node is a dedicated signaling or a common signaling.

7. The user equipment of claim 2, wherein the processor is configured to control the transceiver to receive a signal for indicating a single uplink transmission to the network node or the user equipment is in a single uplink transmission mode.

8. The user equipment of claim 1, wherein if the user equipment and the network node are both feasible of detecting that the IM interference is going to occur, the transceiver is configured to receive a signal for indicating a single uplink transmission to the network node, or receive a signal for configuring the user equipment in a single uplink transmission mode from the network node.

9. A method for identifying interference of a user equipment in a wireless communication system, comprising:
receiving scheduling information from a network node; and
detecting whether an intermodulation (IM) interference is going to occur according to the scheduling information.

10. The method of claim 9, further comprising transmitting a report, to the network node, that if the user equipment is feasible to detect that the IM interference is going to occur.

11. The method of claim 10, wherein the report is transmitted via a dedicated signaling, wherein the dedicated signaling is a radio resource control (RRC) signaling.

12. (canceled)

13. The method of claim 9, wherein the method further comprises:
receiving a signal from the network node, wherein the signal indicates that the network node is feasible to detect that the IM interference is going to occur.

14. The method of claim 13, wherein the signal received from the network node is a dedicated signaling or a common signaling.

15. The method of claim 10, wherein the method further comprises:
receiving a signal for indicating a single uplink transmission to the network node or the user equipment is in a single uplink transmission mode.

16. The method of claim 9, wherein if the user equipment and the network node are both feasible of detecting that the IM interference is going to occur, the method further comprises:
receiving a signal for indicating a single uplink transmission from the network node; or
receiving a signal for configuring the user equipment in a single uplink transmission mode from the network node.

17. A network node for identifying interference in a wireless communication system, comprising:
a memory;
a transceiver; and
a processor coupled to the memory and the transceiver,
wherein the processor is configured to:
control the transceiver to transmit, to a user equipment, scheduling information; and
detect whether an intermodulation (IM) interference is going to occur according to the scheduling information.

18. The network node of claim 17, wherein the transceiver is configured to receive a report that if the user equipment is feasible to detect that the IM interference is going to occur from the user equipment,
wherein the report is received by the transceiver via a dedicated signaling, and
wherein the dedicated signaling is a radio resource control (RRC) signaling.

19. (canceled)

20. (canceled)

21. The network node of claim 17, wherein the processor is configured to control the transceiver to transmit a signal to the user equipment to indicate that the network node is feasible to detect that the IM interference is going to occur wherein the signal transmitted from the network node is a dedicated signaling or a common signaling.

22. (canceled)

23. The network node of claim 18, wherein the processor is configured to control the transceiver to transmit a signal to the user equipment to indicate a single uplink transmission from the user equipment to the network node, or to configure the user equipment in a single uplink transmission mode.

24. The network node of claim 17, wherein if the user equipment and the network node are both feasible of detecting that the IM interference is going to occur, the processor is configured to transmit a signal to the user equipment for indicating a single uplink transmission to the network node, or transmit a signal for configuring the user equipment in a single uplink transmission mode.

25-35. (canceled)
